(19) United States
(12) Patent Application Publication
(10) Pub. No.: US 2021/0389794 A1
(43) Pub. Date: Dec. 16, 2021

(54) PRIVACY FLAPS FOR ELECTRONIC SCREENS

(71) Applicant: Karoly Nagy, Largo, FL (US)

(72) Inventor: Karoly Nagy, Largo, FL (US)

(21) Appl. No.: 16/925,271

(22) Filed: Jul. 9, 2020

Related U.S. Application Data
(60) Provisional application No. 63/037,562, filed on Jun. 10, 2020.

(51) Int. Cl. G06F 1/16; H04B 1/3888

(52) U.S. Cl. CPC G06F 1/1603; H04B 1/3888

(57) ABSTRACT

The present invention revolutionizes the field of mobile screen covers. The invention pertains to foldable Display Shades for computing devices with screen. More specifically, the invention pertains to covering the screen of computing devices with foldable side wings and top wing, creating a Shadow Box against unwanted lights for better visibility and for more privacy at the same time.

### CROSS-REFERENCE TO RELATED APPLICATION(S)

This application claims priority to U.S. Provisional Patent Application No. 63/037,562, filed on Jun. 10, 2020.

### BACKGROUND OF THE INVENTION

### 1. Field of Invention

The present invention pertains to covering the screen of computing devices with foldable side wings and top wing. This creates a Shadow Box against unwanted lights for better visibility and enhances privacy.

### 2. Description of Related Art

Computing devices have visual displays that emit light. The display can be optimized based on lighting conditions. Display visibility can compromised if seen in direct sunlight. Even artificial light-sources night time or excessive lights, reflecting lights, flash lights, back lights, limelight, mirrored lights can cause problems.

People try to cover the screen with their hand temporarily to see it better but this has limitations. For example, someone's hands might be occupied (as in driving) and cannot cover the display of a GPS. This problem can occur anytime anywhere, regardless the timing of the day, or seasons (summer, winter), or outside or inside a building or vehicle.

Privacy is another concern.

People frequently stand or sit really close to each other, specially in public places, such as on trains, subway trains or buses in public waiting rooms, offices, hospitals, and other crowded places. Many of them are very concerned about their privacy and the private and sensitive information that their screen shows, or business secrets or other non-public or protected information.

There are numerous attempts at mobile phone privacy in the prior art.

U.S. Pat. No. 10,033,437 (Bimbaud) discloses a case that includes a base for receiving a portable phone and a flap hinged to the base and including a housing configured to receive a microcircuit card. A first contactless communication antenna is provided in the flap for coupling to an antenna of the microcircuit card. A second contactless communication antenna is provided in the base for coupling to an antenna of the portable phone. The first and second first contactless communication antennae are electrically connected to each other.

U.S. Pat. No. 10,581,480 (Kim) teaches a rotatable mobile phone shell. The rotatable mobile phone shell includes a shell body, a rotating component, a finger gripping component and a spring component. The invention has the effect of safely and conveniently using mobile phone while protecting mobile phone.

U.S. Pat. No. 10,608,690 (Hutchinson) teaches covers for a mobile phone including aspects that protect the phone from impact and/or provide shock absorbance characteristics. Covers can include one or more protrusions that reduce the contact surface to the phone and dissipate energy. Advantageously, the one or more protrusions work with intermittent spaces to provide shock absorbing characteristics and reduce the contact surface area between the cover and the phone. In some embodiments, the protrusions can include a soft-side rectangular shape, where the protrusions are placed in an ordered array in the back wall of a cover. In some embodiments, the one or more protrusions can include a row of x-shaped protrusions interspersed with air pockets along the inside wall of the cover.

U.S. Pat. D779,471 (Tien) teaches a protective cover for a mobile phone.

U.S. Pat. D841,639 (Tien) teaches a mobile phone case.

U.S. Pat. D842,291 (Tien) teaches a mobile phone protective case.

U.S. Pat. D843,363 (Yan) teaches a mobile phone protective case.

The foregoing prior art does not describe the present invention.

### SUMMARY OF THE INVENTION

Privacy flaps for an electronic device, comprising:
a. A body,
b. A left wing,
c. A right wing,
d. A top wing,
e. A bottom stop, and
f. A position fixer.

The left wing of [0016] wherein it contains at least one magnet.

The right wing of [0016] wherein it contains at least one magnet.

The top wing of [0016] wherein it contains at least one magnet.

A means for protecting the privacy of an electronic device, comprising:
a. A body,
b. A left wing,
c. A right wing,
d. A top wing,
e. A bottom stop, and
f. A position fixer.

The left wing of [0020] wherein it contains at least one magnet.

The right wing of [0020] wherein it contains at least one magnet.

The top wing of [0020] wherein it contains at least one magnet.

A means for protecting the privacy of a computer monitor using privacy flaps, comprising:
a. A top part,
b. A bottom part,
c. A left wing,
d. A right wing, and
e. At least one tightening ring.

The top part of [0024] wherein it contains folded slide-tracks

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIG. 1A shows the disclosed invention as a soft Shadow Box (for cell phones, tablets, iPads, palms, others) laid out, in front view.

FIG. 1B shows the disclosed invention as a soft Shadow Box that also equipped with credit card and id holder pockets

FIG. 2A shows the present invention with “Display Shades” as soft Wings with built-in (hidden) magnets and built-in small steel plates for cell phones, closing to its functioning position, creating a Shadow Box.

FIG. 2B shows the Display Shades as Shadow Box with Velcro straps coupling.

FIG. 2C shows the Display Shades as Shadow Box Magnetic Clasps coupling.

FIG. 3 shows the closed case Front side.

FIG. 4 shows the closed case Back side.

FIG. 5 illustrates a soft shortened Wings version, for having more room for easier texting.

FIG. 6A shows the disclosed invention as a hard (or medium-hard) plastic Display Wings (Flaps) with small rotating hinges with long pin running in them.

FIG. 6B shows the hard (or medium-hard) plastic Display Flip with rotating hinges, in shade position (or privacy position) with a cell phone.

FIG. 6C shows the hard (or medium-hard) plastic ‘Display Shades’ with rotating hinges, in shade position with a self-adhesive sticker for fixing the device.

FIG. 6D shows a hard (or medium-hard) ‘Display Shades’ with small holder for identification cads or credit card.

FIG. 6E shows the hard Display Wings hold together with soft bands which could be glued or heat-welded to the Wings.

FIG. 6F shows a hard Display Flips in almost closed position.

FIG. 6G shows the hard Display Wing(s) from above.

FIG. 7A shows the disclosed invention as a hard (or medium-hard) shadow box built together with a (vehicle) device holder with suction cup.

FIG. 7B shows the disclosed invention as a hard (or medium-hard) ‘Display Shades’ built together with a vent-mount vehicle device holder.

FIG. 8A illustrates the multi-position version of the disclosed invention as an adjustable slide-out shades for a computer monitor, from the above view.

FIG. 8B shows multi-position adjustable slide-out Display Shades for a monitor, from above, as it is attached to the screen.

FIG. 8C shows a multi-position adjustable slide-out Display Shades on a monitor, as it is attached to the screen and the wings are folded downward.

FIG. 8D shows this multi-position adjustable slide-out Display Shades on a Laptop, as it is attached to the screen and the wings are folded downward.

### DETAILED DESCRIPTION OF PREFERRED EMBODIMENTS

The present invention solves a number of problems of the prior art.

The present invention revolutionizes the field of mobile screen covers.

The invention pertains to foldable Display Shades for computing devices with screen. More specifically, the invention pertains to covering the screen of computing devices with foldable side wings and top wing, creating a Shadow Box against unwanted lights for better visibility and for more privacy at the same time.

The present invention can be used for any visual display computing device such as cell phones, tablets, palms, iPads, ThinkPads, idea pads, GPS devices notebooks, laptops, chrome books, netbooks, MacBooks, workstations flat screen desktop monitors, flat screen TVs, digital cameras, dash cams, digital rearview mirrors on windshields, and all kind of computing device with displays or screen.

The present invention can be used for any visual display computing device such as cell phones, tablets, palms, iPads, ThinkPads, idea pads, GPS devices notebooks, laptops, chrome books, netbooks, MacBooks, workstations flat screen desktop monitors, flat screen TVs, digital cameras, dash cams, digital rearview mirrors on windshields, and all kind of computing device with displays or screen.

The functionality of the foldable Display Shades (Display Flips) is simple. When the user chooses to use the shades (wings) s/he just folds them out and match them (couple them) together. When the user doesn't want to use his/her device anymore, simply just un-couple the wings and fold them and close them on each other over the screen.

### Advantages

The present invention has many advantages over the prior art.

Shadow—covering the screen from excessive lights, flash lights, back lights, limelight, mirrored lights as well as any unwanted lights that interfere with the light emission of the electronic display, or bothers the human eye seeing the screen content well.

Privacy—it helps to cover the screen from unwanted attention of other people, regardless it's a private device (a personal phone) or a company owned device (a business tablet) hiding sensitive information or trade secrets, legal secrets, etc.

Energy saving—because the Wings provide shadow the user doesn't have to use such a high light power, so it saves a bit of battery power.

Case—although its primary function is not being a case, it can work like that, and the user doesn't even need a flexible direct case (in everyday language: ‘rubber case’) cause the Top wing and the bottom holder don't let the device slip out of the Shadow Box.

Protection—the wings are serving as a little more protection, because it has 2 layers covering the screen, unlike a regular phone wallet or flip case where there is only one layer. The above mentioned points are answering the questions: “What is it good for?” and “What are the goals of that?”

Field of Use—in any season, not just summer, even winter time we could have strong sunlight or sun-reflection from snow or because of other things. Both outdoor and indoor. Outdoor daytime: streets, parks, parking lots, public places, beaches, public gatherings, outdoor night-time: reflecting lights, concerts, sport events, etc, indoor daytime or even in cars using GPS specially at sunrise and sunset times, offices, shopping malls, indoor night-time: concerts, great events, because of neon lights, flashing lights, reflecting lights, etc.

Using it as privacy shades in public places, regardless indoor, outdoor, daytime, night-time: trains, subway trains or buses or public waiting rooms, offices, hospitals, airports, airplanes, and other crowded places.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

Reference is made to the figures of the invention included herein. A detailed description of the figures follows below.

### Example One

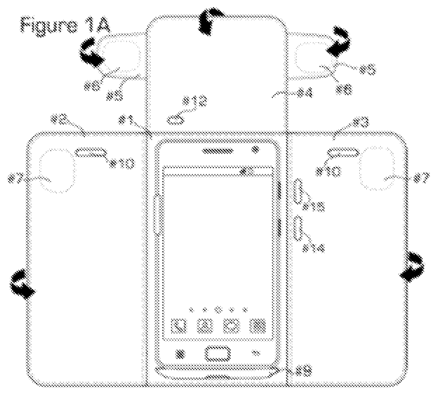

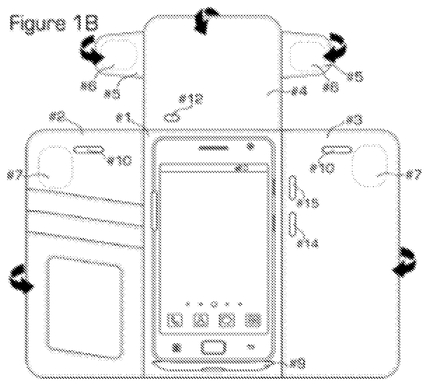

Reference is made to FIG. 1A, which shows the disclosed invention as a soft Shadow Box (for cell phones, tablets, iPads, palms, others) laid out, in front view

Reference is also made to FIG. 1B, which shows the disclosed invention as a soft Shadow Box that also equipped with pockets to hold credit card and identification card.

Item (#1) is the body of the soft shadow box.

Item (#2) is the Left side Wing or Shade (left Flap).

Item (#3) is the Right side Wing or Shade (right Flap).

Item (#4) is the Top Wing or Shade (top Flap).

Item (#5) is the position fixer small flap for easy and fast coupling for joining the Wings temporarily.

Item (#6) is a magnet (could be built-in, hidden or exposed, could be rounded or square or magnetic clasps or other—shape doesn't matter, it's optional).

Item (#7) is a small steel plate in the position fixer small flaps (#5) and in the upper part of the back side (#1) when the Display Shades are totally closed. The steel plates could be built-in (hidden) or exposed, rounded or square or other—shape is optional, doesn't change the function They could be magnets, too, it's the choice of the factory, but not really necessary to use double magnet coupling, magnet to steel plate is strong enough for this function, this way no magnet will be close to the Display when the wings are closed, only the steel plates.

Item (#9) is the “bottom stop”, which holds the phone in the case and has a hope for the charging plug.

Item (#10) is a cut-out ‘part’ for speaker to be able to hear the voice (or music).

Item (#12) is a hole on the Top Wing for microphone/headphone plug.

Item (#14) is a cut-out for power button.

Item (#15) is a cut-out for volume button

Items (#1) and (#2) and (#3) and (#4) and (#5) are built in together (for example sewn together).

The magnets (Item (#6)) are built into the position fixer small flap(s) (#5). In a preferred embodiment, this is hidden in the flaps.

The small steel plate(s) (Item (#7) are built inside the Left Wing (Item (#2)) and inside the Right Wing (Item (#3)), so when the user folds the Top Wing (#4) the magnets (in the small flaps) can snap to the small steel plates (#7), thus fixing the top (#4) to the Wings. This allows the 3 wings to form an almost full shadow-box around the Display (screen).

### Example Two

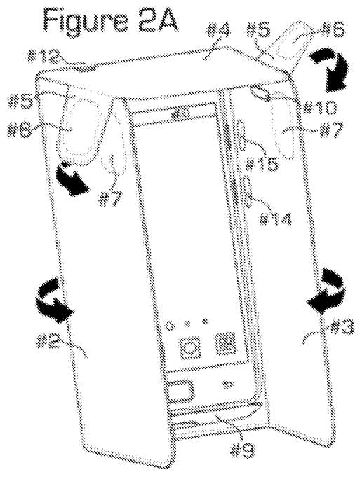

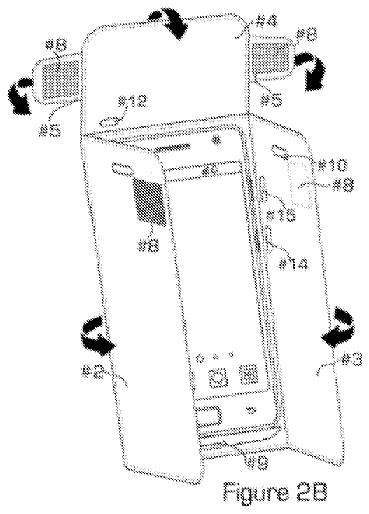

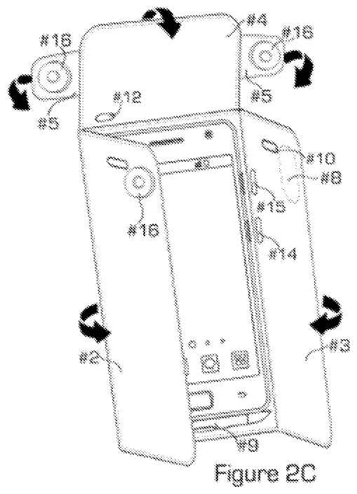

Reference is made to FIG. 2A, which shows the present invention with “Display Shades” as soft Wings with built-in (hidden) magnets (Item (#6)) and built-in (hidden) small steel plates for cell phones, closing to its functioning position, creating a Shadow Box.

The Left Wing (Item (#2)) and Right Wing (Item (#3)) are folded ahead in 90 degree to the Display. At the same time, the Top Wing is also folded ahead down in 90 degree to the Display, then the small flaps (Item (#5)) with the magnets inside will snap to the side Wings, because the magnets are being drawn to the small steel plates (Item (#7)) built inside the side Wings (Items (#2) and (#3)). As a result, the three wings together form an almost full shadow-box around the Display (screen), giving the desired shades or privacy coverage from unwanted attention.

Reference is made to FIG. 2B, which shows the Display Shades as Shadow Box with Velcro straps coupling (Item (#8)).

Reference is made to FIG. 2C, which shows the Display Shades as Shadow Box Magnetic Clasps coupling.

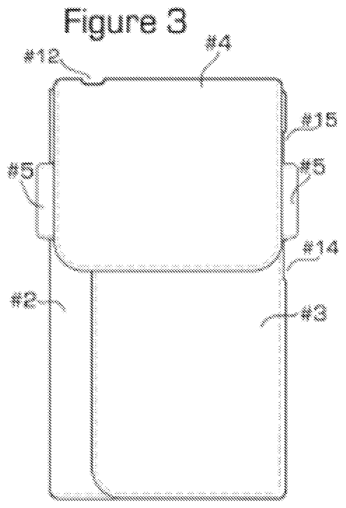

Should the user not want to use the wings, the user could just simply folds them back to the back side, and attach the magnet to the small plate of that wing which folds under the op wing. The user just has to fold the small flap (#5) a bit over the Wing so it can snap to the small steel plate. The users can do that with the soft case. This is demonstrated in FIG. 3.

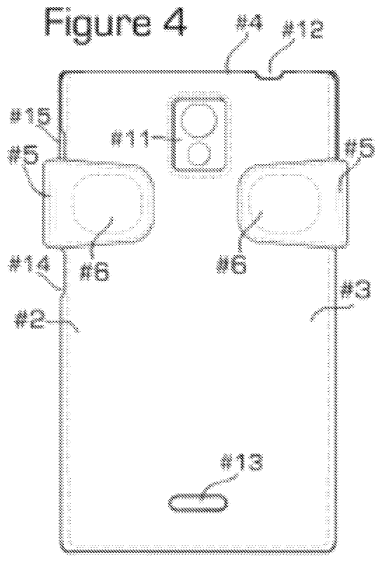

Should the user not want use his or her device anymore, the user can collapse the wings, just folding the 2 side wings on the Display (screen) and the Top Wing (#4) upon the Wings, matching the small flaps (#5) to the back side to the small steel plate(s) (or one long steel plate) built-in the back. This is demonstrated in FIG. 4.

### Example Three

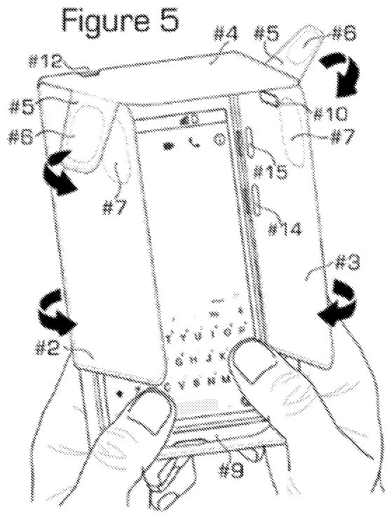

Reference is made to FIG. 5, which a soft shortened Wings version, for having more room for easier texting.

### Example Four

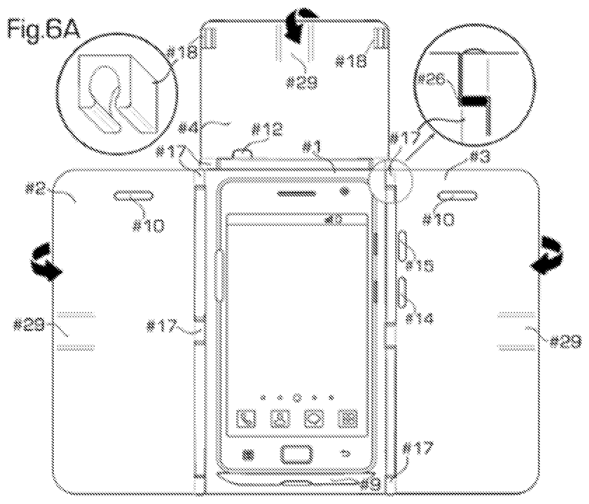

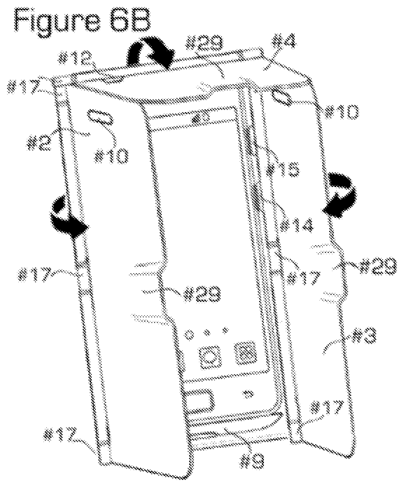

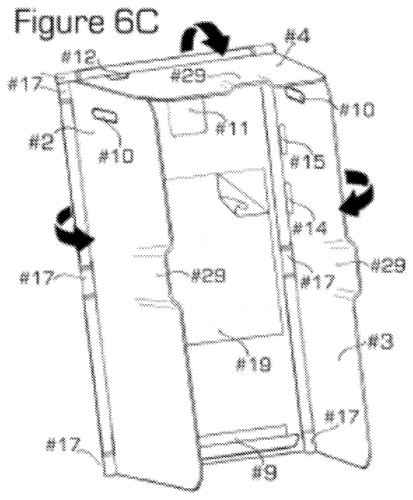

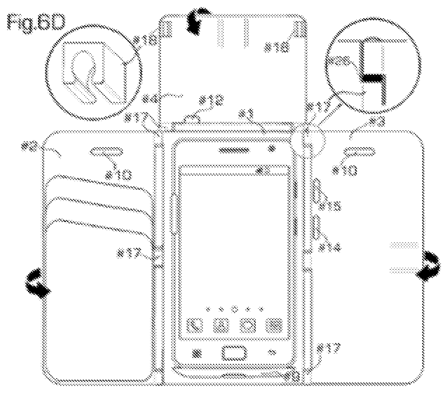

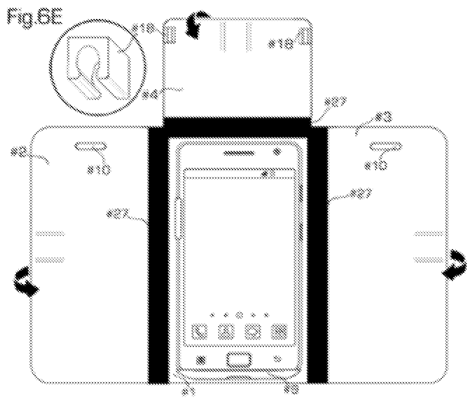

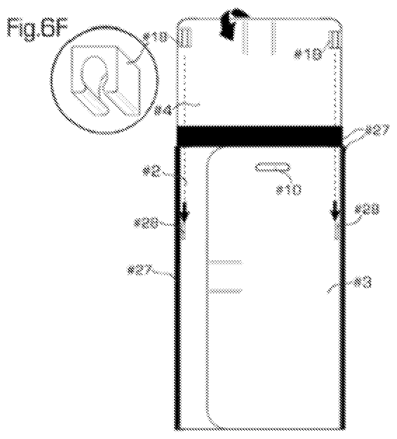

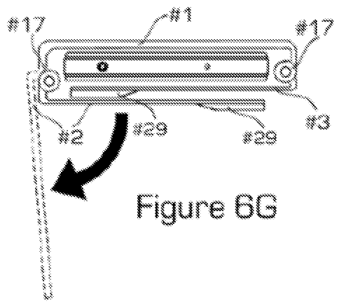

Reference is made to FIG. 6A, which shows the disclosed invention as a hard (or medium-hard) plastic Display Wings (Flaps) with small rotating hinges with long pin running in them. These have small snap-on couplings (#18) for fixing the Top wing to the side Wings for 90 degree shade functionality, which are not necessary if the hinges are tight enough or having some tightening rings or squeezing washers (#26) with them what always keep them tight.

Reference is made to FIG. 6B, which shows the hard (or medium-hard) plastic Display Flip with rotating hinges, in shade position (or privacy position) with a cell phone.

Reference is made to FIG. 6C, which shows the hard (or medium-hard) plastic ‘Display Shades’ with rotating hinges, in shade position with a self-adhesive sticker for fixing the device (#19).

Reference is made to FIG. 6D, which shows a hard (or medium-hard) ‘Display Shades’ with small holder for identification cards or credit card.

Reference is made to FIG. 6E, which shows the hard Display Wings hold together with soft bands (#27) which could be glued or heat-welded to the Wings. The material of the soft bands or strips (#27) could be, but is not limited to, rubber, silicon, faux leather, PLT, TPU, fabric, cotton, etc.

Reference is made to FIG. 6F, which shows a hard Display Flip in almost closed position, noticeable that the small snap-on couplings (#18) will be snap-on (or squeezed on) the small snap-on bits to fix the Top to that Wing to hold them together safely.

Reference is made to FIG. 6G, which shows the hard Display Wing(s) from above as the Left Wing (#2) is opening, the 90 degree curve is in the back plate (#1) so the side Wings can close on the screen comfortably.

### Example Five

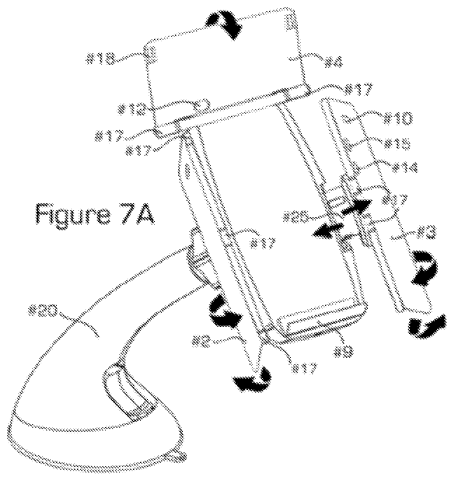

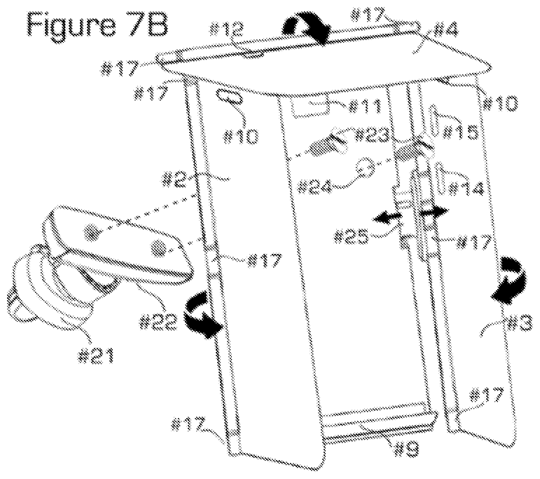

Reference is made to FIG. 7A, shows the disclosed invention as a hard (or medium-hard) shadow box built together with a (vehicle) device holder with suction cup, and (as suggested) with adjustable side gripper (#25) to squeeze and fix the device. (This picture is not an instruction how to exactly build it up, it's just merely an illustration that the Display Shades (Flips) can be used and very useful in vehicles, could be constructed with suction cup or vent-mount or other variation, and depends on its size it could hold a cell phone or Tablet or iPad or other computing device.)

It's noticeable that the Top Wing is wider (horizontally) than in the former illustrations, (preferred in vehicles), because the Top should be wider for better coverage, so it would still provide a full coverage (shadow) even if the side wings wouldn't be in 90 degree to the screen, but in other angle, since the user (driver) would want to turn the Wings in a certain angle.

Reference is made to FIG. 7B, which shows the disclosed invention as a hard (or medium-hard) ‘Display Shades’ built together with a vent-mount vehicle device holder and (as suggested) with adjustable side gripper to squeeze and fix the device. Here, too, the Top Wing is wider (horizontally) than in the former illustrations, so the user (driver) can turn the Wings in a desired angle.

### Example Six

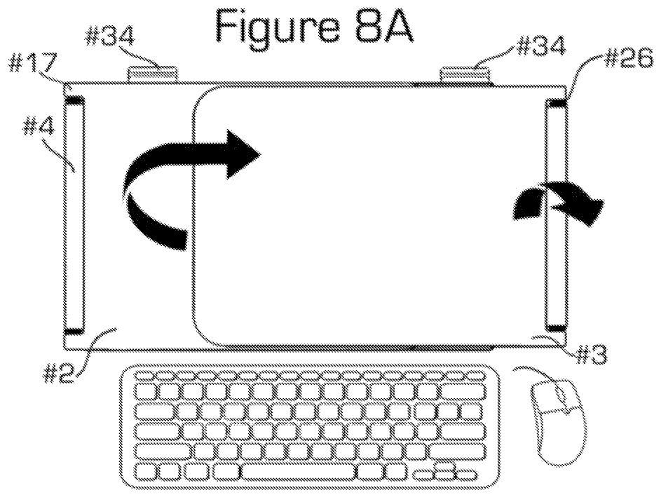

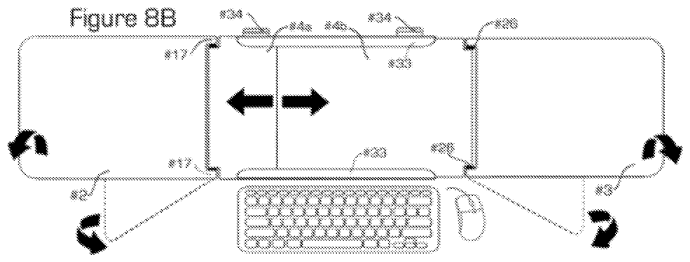

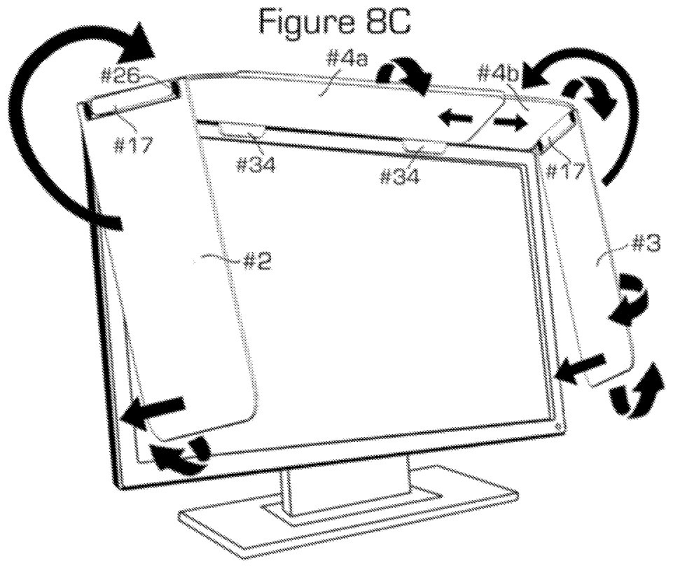

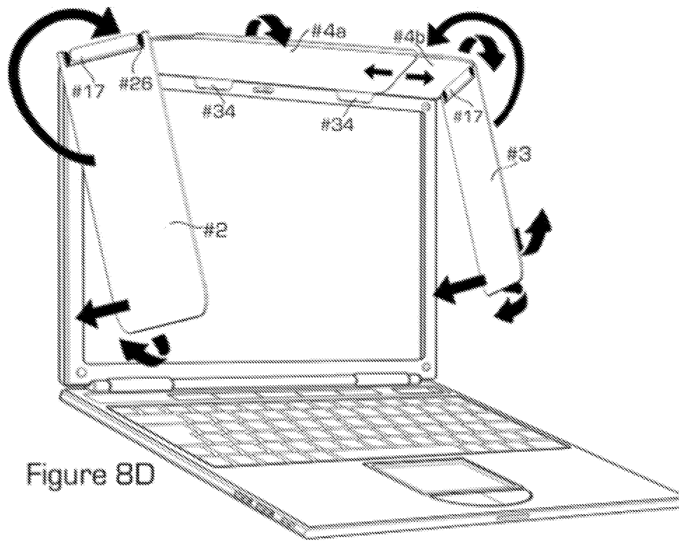

Reference is made to FIG. 8A, which illustrates the multi-position version of the disclosed invention as an adjustable slide-out shades for a computer monitor, from above view, as it is attached to the screen and the wings are still resting on each other and on the Top. The advantage of this slide-out version is: it can be adjusted to the size of the screen, regardless it's larger or if the user wants to use it on another differently sized monitor.

Reference is made to FIG. 8B, which shows this multi-position adjustable slide-out Display Shades for a monitor, from above, as it is attached to the screen. The Top (#4) is composed of two pieces: the main part of the Top has folded-back slide-tracks (#33) wherein the second part of the Top slides in and out (straight arrows) being adjusted to the size of the monitor, and the wings are folded out, and the dashed line parts show as they fold down.

Reference is made to FIG. 8C, which shows a multi-position adjustable slide-out Display Shades on a monitor, as it is attached to the screen and the wings are folded down going to close to 90 degree position to the screen. It is envisioned that this embodiment would be exceptionally useful on an electronic device near a window during daytime hours.

Reference is made to FIG. 8D, which shows this multi-position adjustable slide-out Display Shades on a Laptop, as it is attached to the screen and the wings are folded down going to close to 90 degree position.

These numbers correspond to structures in the foregoing figures: (#1): the body (or back side); (#2): Left side Wing or Shade (left Flap); (#3): Right side Wing or Shade (right Flap); (#4): Top Wing or Shade (top Flap); (#5): position fixer small flap—easy and fast coupling for joining the Wings temporarily; (#6): magnet (could be built-in, hidden or exposed, could be rounded or square or magnetic clasps or other—shape doesn't matter, it's optional); (#7): small steel plate in the position fixer small flaps; (#8): Velcro strap parts; (#9): Bottom stop (holding the phone, not letting it slide out, has a hole for charging plug); (#10): cut-out ‘part’ for speaker to be able to hear the voice (or music); (#11): cut-out on back side for the camera; (#12): hole on the Top Wing for microphone/headphone plug; (#13): cut-out ‘part’ on the back side for the back side speaker; (#14): cut-out for power button; (#15): cut-out for volume button; (#16): magnetic clasp—hammered on the material of the Wing(s) and on small flaps by factory; (#17): hinge (or closed hinge) for the rotation of hard plastic Wings; (#18): small snap-on (or snap-in or squeeze-on) coupling (for fixing the Top wing to the side Wings—not necessary if the hinges are tight enough having some small rubber washers); (#19): self-adhesive sticker (a stick-to coupling); (#20): car phone holder with suction-cup; (#21): vent-mount holder (with squeezing nut); (#22): back plate for vent-mount holder; (#23): screw (for fixing the Display Shades to the back plate of the vent-mount); (#24): hole for the screw on the back side of the Display Shade; (#25): adjustable gripper (to squeeze and fix the device); (#26): tightening ring or squeezing washer (rubber or silicone or other flexible material); (#27): soft band or rubber strip (to connects the Top and wing(s); (#28): snap-on bit (to fix the Top to the Wing through squeeze-on (#18); (#29): small lifted area (bulge) for finger (nail) to open the Wing easier (not necessary but recommended for the hard plastic version); (#30): open hinge or click-in hinge for (less expensive) rotating solution; (#33): folded-back slide-tracks; and (#34): attachment clips to secure the Display Shades to an electronic screen.

Other Variations

There could be several variation of Display Shades (Display Flaps) for example: soft shadow box: equipped with a direct-holding phone case (for example: tight rubber case), or without a case with only a bottom holder, with magnets (FIG. 2A), or Velcro straps (FIG. 2B), or magnetic clasps (FIG. 2C); with or without extras like id holder pockets; shortened Wings for better texting option (soft or hard material) See FIG. 5; hard (or medium-hard).

Wing Variations

Wings with rotating hinges and a long pin in them (in this variation there should be a 90 degree turn in the wing near to the hinge(s)—or on the back plate (#1) for perfect closing on the screen because of the thickness of the phone or other device. This is shown in FIGS. 6A and 6G.

In the alternative, instead of hinges, the wings and black plate (#1) are connected by a relatively soft band or strip, glued or heat-welded to the wing(s) and the back plate (#1), in this version no holes (volume, power) needed on the Wings or on the 90 degree curved part of the back plate, because the buttons can be pushed through the soft strip (i.e. rubber band). This is shown in FIG. 6E,

A hard wing version might be better for men and professionals as well as great for vehicle computing device holders.

Other embodiments include a “stick-to” version, wherein a self-adhesive sticker is used to mount the device. A vehicle computing device holder shades (shadow box) could be with suction-cup or vent-mount or other solution, suggested with adjustable side(s) (“pull-out and squeeze it”) one side or both sides (one side is enough).

Materials

There are numerous options for the material of Display Shades (Display Wings, Shadow Box) it depends which type of variation.

For soft shadow box or the hard flaps with hinges, it could be a relatively soft material like plastic leather imitation or plastic textures (PU or TPU) similarly to cell phone wallets or flip-cases, or a medium soft (or medium hard) material like a plastic woven texture (like new type of laptop cases), or a fabric, cloth.

For hard Flips version a relatively hard material like a hard or medium hard plastic.

Highly durable and impact-resistant materials are suggested to be used.

The List of materials include, but are not limited to, soft: natural real (genuine) leather, faux leather (artificial leather, leather imitation) Polyurethane and different type of polyurethane, Polyester, Thermoplastic, microfiber, soft or medium soft rubber, silicone, latex, or similar to these, as well as cotton, canvas, denim, silk, or even wool; hard: polycarbonate, hard polyurethane, polypropylene, or similar to the like.

I claim:

1. Privacy flaps for an electronic device, comprising:
a. A body,
b. A left wing,
c. A right wing,
d. A top wing,
e. A bottom stop, and
f. A position fixer.

2. The left wing of claim 1 wherein it contains at least one magnet.

3. The right wing of claim 1 wherein it contains at least one magnet.

4. The top wing of claim 1 wherein it contains at least one magnet.

5. A means for protecting the privacy of an electronic device, comprising:
a. A body,
b. A left wing,
c. A right wing,
d. A top wing,
e. A bottom stop, and
f. A position fixer.

6. The left wing of claim 5 wherein it contains at least one magnet.

7. The right wing of claim 5 wherein it contains at least one magnet.

8. The top wing of claim 5 wherein it contains at least one magnet.

9. A means for protecting the privacy of a computer monitor using privacy flaps, comprising:
a. A top part,
b. A bottom part,
c. A left wing,
d. A right wing, and
e. At least one tightening ring.

10. The top part of claim 9 wherein it contains folded slide-tracks
